(19) United States
(12) Patent Application Publication
(10) Pub. No.: US 2008/0190698 A1
(43) Pub. Date: Aug. 14, 2008

(54) Extending, Folding Ladder Comprising a Single Central Post

(76) Inventors: Bernard Amalric, L'Union (FR); Christian Migrenne, Toulouse (FR); Jean-Paul Taillefer, Buzet Sur Tarn (FR)

Correspondence Address: YOUNG & THOMPSON, 209 Madison Street, Suite 500, ALEXANDRIA, VA, 22314, US

(21) Appl. No.: 11/914,265

(22) PCT Filed: Apr. 21, 2006
(86) PCT No.: PCT/FR2006/000884

§ 371 Date: Nov. 21, 2007

(30) Foreign Application Priority Data
May 13, 2005 (FR) 05/4809

(51) Int. Cl. E06C 1/38; E06C 1/54

(52) U.S. Cl. 182/207; 182/196

(57) ABSTRACT

The invention relates to an extending, folding ladder comprising a single post (1) which is disposed in the symmetry plane thereof and which is formed by an assembly of segments (2) and adjacent segments (3) of the same length, each segment and the corresponding adjacent segment being articulated with one another at the midpoint thereof. In addition, the ends of consecutive segments are articulated with one another, such that the distances between two successive articulations are identical. The inventive ladder is deployed by manually extending the constituent parallelograms until the ladder is fully extended and said process is performed in reverse in order to retract the ladder for storage. The rungs (4) of the ladder are positioned at the midpoint articulation between two opposing segments or at each articulation between two successive segments on the front face of the ladder. The articulations between two successive segments on the rear face of the ladder are not equipped with rungs. Moreover, the midpoint of each rung (4) is fixed to one segment (2) and articulated with the adjacent segment (3) thereof. The bottom rung is connected to a ground support element, while the top rung is connected to a pad-equipped element which rests against the wall in order to stabilise the ladder. A retractable hook (11) is used to lock the parallelogram assembly. In addition, the inventive extending, folding ladder can be used to form a variable-height table stand, a variable-height full table or a folding stepladder simply by deploying the ladder only partially or by removing some of the aforementioned articulated connections and adding stabiliser bars.

The subject matter of this invention is a folding extensible ladder with a single central upright.

Numerous alternatives exist for extending or extensible ladders designed to be folded up so that they take up little space, so as to facilitate the transporting thereof by vehicle or else so that they can be stored in small spaces.

One well-known principle is based on the support structure having several segments arranged in a series of parallelograms, enabling it to expand according to an extensible geometry. It is on this principle, for example, that the U.S. Pat. No. 3,265,155, No. 3,004,624 and No. 2,798,653 are based: the two uprights consist of a set of segments hinged together to form a series of parallelograms capable of being extended. In some cases, each upright itself consists of two adjoining support structures wherein numerous parts are present. It is understood that, although such architectures respond more or less satisfactorily to the stated problem, they lead to the item being complex to produce and have a major disadvantage, which is the risk of sliding one upright in relation to the other, knowing that there is actually no true, sufficiently rigid mechanical union between them, which is capable of contributing to perfectly synchronized kinematics.

The very essence of this invention is to simplify the design concept of the ladder very significantly by constructing the parallelogram kinematics around a single central upright, offering numerous advantages: very pure kinematics, therefore with no risk of jamming, the minimum number of parts in order to limit the cost of production, the most rigid extended configuration possible, and finally the most compact folded configuration possible.

### DISCLOSURE OF THE INVENTION

The ladder that is the subject matter of the invention consists essentially of one single upright located in the plane of symmetry thereof, a set of rungs, support shoes at both ends and a safety lock.

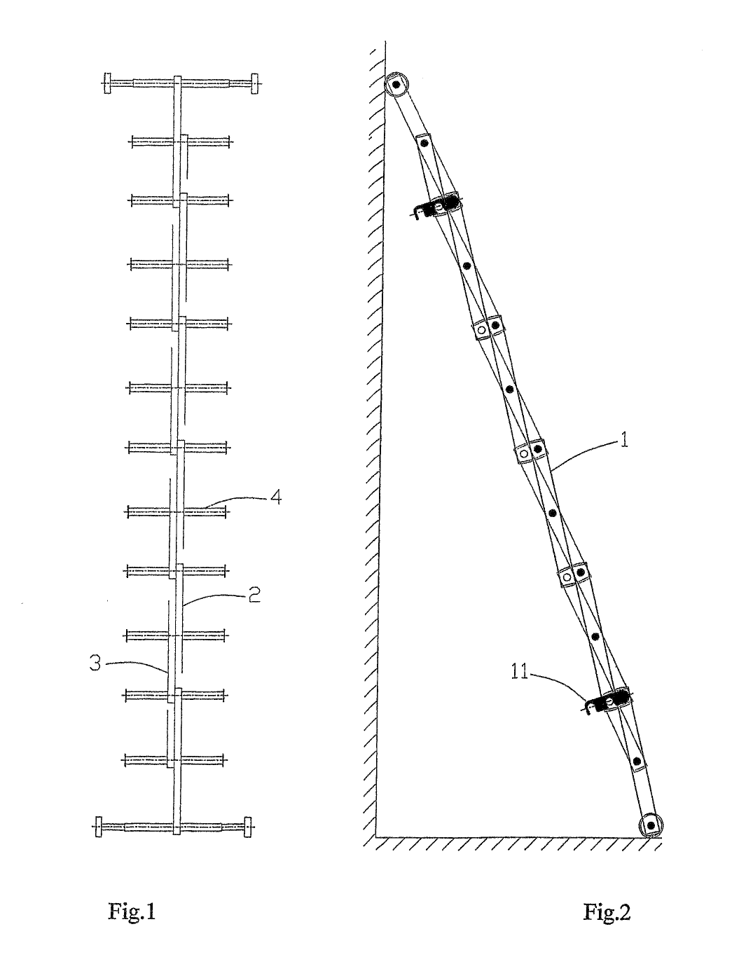

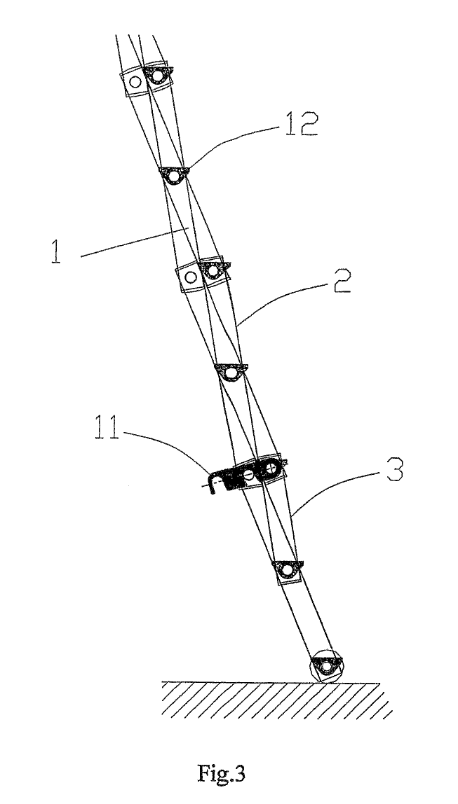

FIG. 1, a front view, FIG. 2, a profile view and FIG. 3, s a profile view with rungs equipped with steps, show the ladder in the fully extended position, the configuration used most typically.

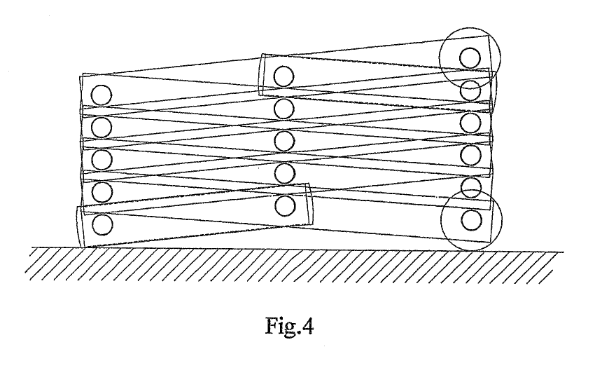

FIG. 4 shows the ladder in the completely folded-up, storage position.

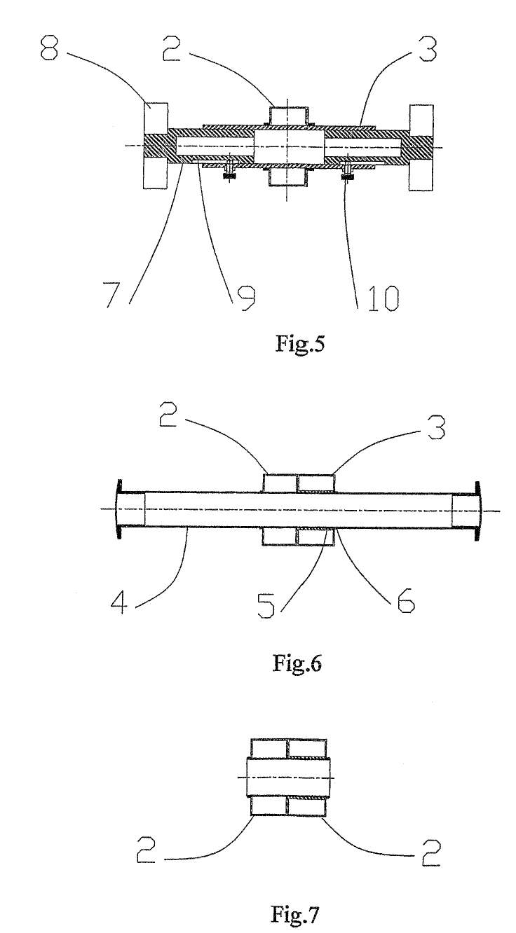

FIG. 5 shows a detail of the first rung and of the last rung of the ladder, along with the extension system thereof, which is intended to spread apart the supports.

FIGS. 6 and 7 show details of various hinge arrangements between the upright segments: the hinge located at the front portion functioning simultaneously as a pivot hinge and a rung, the hinge located at the rear portion having a single function as a pivot hinge.

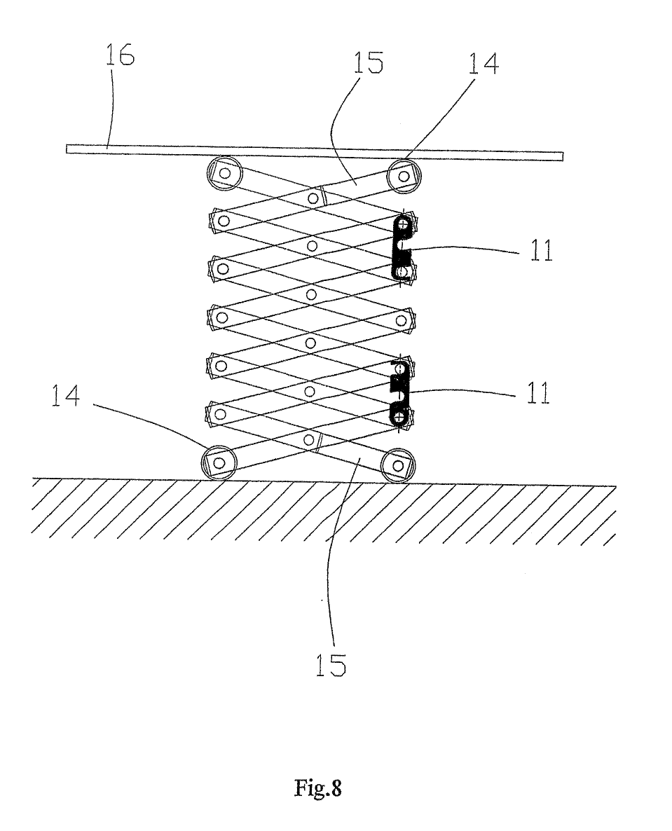

FIG. 8 shows the possible use of the extensible ladder to produce an adjustable-height table stand.

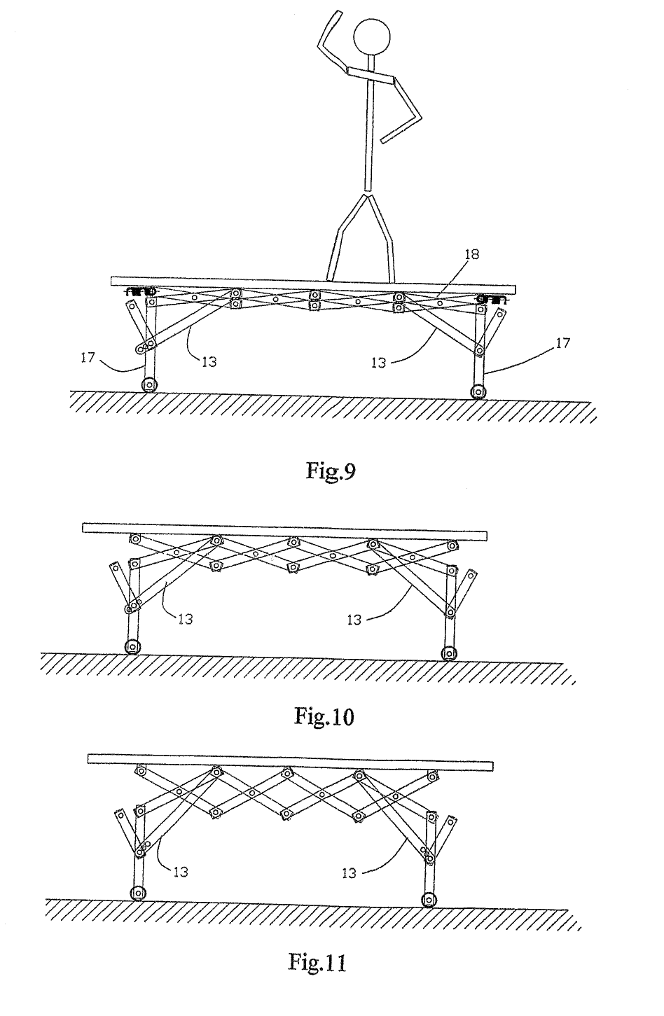

FIG. 9, FIG. 10 and FIG. 11 show the possible use of the extensible ladder to produce a complete, adjustable-height table.

FIG. 11 shows a possible conversion of the extensible ladder into an extensible stepladder.

The upright 1 is produced from metal sections made of a light alloy, or optionally of any other light material such as composite or plastic materials. It consists of a set of segments 2 and adjoining segments 3 of the same length. Each segment and the associated adjoining segment thereof are hinged together at the midlines thereof. Two consecutive segments are hinged at the ends thereof. The distances between two successive hinges are all identical. The rungs 4 of the ladder can be made from cylindrical tubes. They are located either at the middle hinge of two opposing segments, or at each hinge of two successive segments located at the front side of the ladder, as shown in FIG. 6. The hinges between two successive segments located at the rear side of the ladder do not have any rung, as shown in FIG. 7. Each rung 4 is fastened in the middle thereof to the segment 2 by gluing, welding or any other means of fastening. It is hinged to the adjoining segment 3 having a rotating guide spacer 5. A lock ring 6 ensures that the assembly is held in place transversely.

The bottom rung is joined to an element ensuring support on the ground while the top rung is joined to an element ensuring wall support in order to ensure stability of the ladder. In the specific case shown in FIG. 5, these elements may simply consist of two spindles 7 provided at the ends of a support shoe 8. These spindles slide inside the rung so as to be extended for the working phase of the ladder, or retracted for the purpose of reducing the overall spatial requirements during the storage phase. The spindles are provided with a longitudinal groove 9 so that the set screws 10 passing through the rung ensure the rotational and axial locking thereof. The retractable hook 11 hinged to one of the segments can tilt so as to hook onto the closest rung, which immobilizes all of the parallelograms. To improve comfort, it should be noted that each of the rungs should be equipped with a step 12 having a flat surface as shown in FIG. 3.

Implementation of the ladder is simple: the parallelograms are extended manually, until the maximum degree of extension has been obtained, i.e., until each of the consecutive segments is supported on the edge thereof. The retractable hook 11 is brought down onto the rung in order to lock the assembly. The support shoes 8 are extended laterally and then locked in position by tightening the set screws 10. Implementation of the storage configuration is carried out in reverse order.

Within the framework of one particular use, the ladder can be extended partially, as shown in FIG. 8, in order to produce a variable-height table stand. In this case, the locking hooks 11 are locked onto the rungs in an intermediate position intended for this purpose. Furthermore, two additional shoes 14 fastened to a removable support 15 nest in each of the end segments at the upper and lower portions, whereby on the one hand the four shoes and on the other hand the table top supports 16 ensure proper stability of the table thus made.

In FIG. 9, FIG. 10 and FIG. 11, it can be seen that it is possible to produce a complete, height-adjustable table from the extensible ladder. Simply two of the hinged connections are eliminated to form the two legs 17, and then two stabilizer bars or struts 13 ensure that the legs and table top 18 are locked in place angularly in relation to one another.

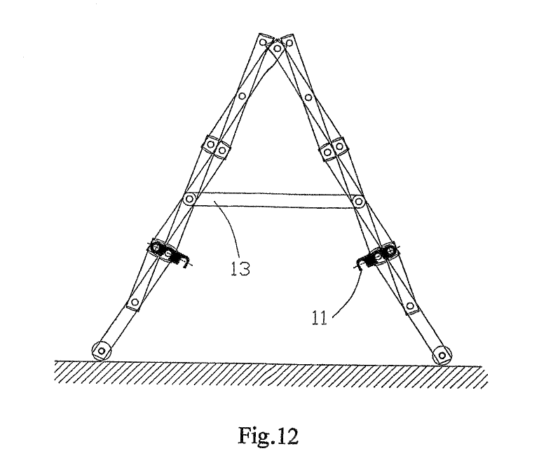

In FIG. 12, it can be seen that the invention can be simply reduced to an extensible step ladder that can be made from an extensible ladder from which one of the hinged connections located in the middle of the ladder would be eliminated and the stability of which would be ensured by two retractable hooks 11 and one stabilizer bar 13.

1. Extensible folding ladder, characterised in that the single upright (1) thereof, located in the plane of symmetry thereof, produced from metal sections made of a light alloy, or possibly of any other light material such as composite or plastic materials, consisting of a set of segments (2) and adjoining segments (3) of the same length, each segment and the associated adjoining segment thereof being hinged together at the middle, the consecutive segments being hinged at the ends thereof, the distances between two successive hinges all being identical, implementation of the ladder being carried out by extending the parallelograms manually until the maximum degree of extension has been obtained, i.e., until each of the consecutive segments is supported on the edge thereof, while the storage configuration operation is carried out in reverse order.

2. Extensible folding ladder according to claim 1, characterised in that the rungs (4) thereof are located either at the middle hinge of two opposing segments or at each hinge of two successive segments but arranged at the front side of the ladder, the hinges between two successive segments located at the rear side of the ladder not having any rungs, each of the rungs (4) being fastened at the middle thereof to the segment (2) and hinged to the adjoining segment thereof (3) having a rotating guide spacer (5) and a lock ring (6) to ensure that the assembly is held in place transversely.

3. Extensible folding ladder according to claim 1, characterised in that the bottom rung is joined to an element ensuring support on the ground while the top rung is joined to an element ensuring wall support in order to ensure stability of the ladder, these elements being capable of being made of simply two spindles (7) equipped at the ends with a support shoe (8) and capable of sliding inside the rung so as to be extended for the working phase of the ladder, or retracted, for the purpose of reducing the overall spatial requirements during the storage phase, these spindles being provided with a longitudinal groove (9) so that the set screws (10) passing through the rung ensure the rotational and axial locking thereof, and then a retractable hook (11) hinged to one of the segments, which can tilt so as to hook onto the closest rung in order to ensure immobilization of all of the parallelograms, the rungs being possibly equipped with a step (12) having a flat surface, in order to improve comfort.

4. Extensible folding ladder according to claim 1, characterised by the partial extension thereof, in order to produce a variable-height table stand, in which case the locking hooks (11) are locked onto the rungs in an intermediate position intended for this purpose, and furthermore, two additional shoes (14) fastened onto a removable support (15) nest together with each of the end segments at the upper and lower portions, whereby on the one hand the four legs and on the other hand the table top supports (16) ensure proper stability of the table thus made.

5. Extensible folding ladder according to claim 1, characterised by the partial extension thereof, in order to produce a complete, adjustable-height table, such that two of the hinged connections are eliminated so as to produce the two legs (17), then two stabilizer bars or struts (13) ensure that the legs and table top (18) are locked in place angularly in relation to one another.

6. Extensible folding ladder as claimed in claims claim 1, characterised in that the elimination of a hinged connection located at the middle of the ladder enabling the rapid conversion thereof into a folding stepladder, the stability of which is ensured by two retractable hooks (11) and one stabilizer bar (13).

7. Extensible folding ladder according to claim 2, characterised by the partial extension thereof, in order to produce a variable-height table stand, in which case the locking hooks (11) are locked onto the rungs in an intermediate position intended for this purpose, and furthermore, two additional shoes (14) fastened onto a removable support (15) nest together with each of the end segments at the upper and lower portions, whereby on the one hand the four legs and on the other hand the table top supports (16) ensure proper stability of the table thus made.

8. Extensible folding ladder according to claim 3, characterised by the partial extension thereof, in order to produce a variable-height table stand, in which case the locking hooks (11) are locked onto the rungs in an intermediate position intended for this purpose, and furthermore, two additional shoes (14) fastened onto a removable support (15) nest together with each of the end segments at the upper and lower portions, whereby on the one hand the four legs and on the other hand the table top supports (16) ensure proper stability of the table thus made.

9. Extensible folding ladder according to claim 2, characterised by the partial extension thereof, in order to produce a complete, adjustable-height table, such that two of the hinged connections are eliminated so as to produce the two legs (17), then two stabilizer bars or struts (13) ensure that the legs and table top (18) are locked in place angularly in relation to one another.

10. Extensible folding ladder according to claim 3, characterised by the partial extension thereof, in order to produce a complete, adjustable-height table, such that two of the hinged connections are eliminated so as to produce the two legs (17), then two stabilizer bars or struts (13) ensure that the legs and table top (18) are locked in place angularly in relation to one another.

11. Extensible folding ladder as claimed in claim 2, characterised in that the elimination of a hinged connection located at the middle of the ladder enabling the rapid conversion thereof into a folding stepladder, the stability of which is ensured by two retractable hooks (11) and one stabilizer bar (13).

12. Extensible folding ladder as claimed in claim 3, characterised in that the elimination of a hinged connection located at the middle of the ladder enabling the rapid conversion thereof into a folding stepladder, the stability of which is ensured by two retractable hooks (11) and one stabilizer bar (13).
